(19) United States
(12) Patent Application Publication
(10) Pub. No.: US 2014/0234817 A1
(43) Pub. Date: Aug. 21, 2014

(54) SYSTEMS AND METHODS FOR HELPING STUDENTS ACHIEVE ACADEMIC SUCCESS AND PERSIST THROUGH COLLEGE

(71) Applicant: Persistence Plus LLC, Cambridge, MA (US)

(72) Inventors: Jill L. FRANKFORT, Charlestown, MA (US); Kenneth N. Salim, Charlestown, MA (US)

(73) Assignee: Persistence Plus LLC., Cambridge, MA (US)

(21) Appl. No.: 14/181,377

(22) Filed: Feb. 14, 2014

Related U.S. Application Data
(60) Provisional application No. 61/765,668, filed on Feb. 15, 2013.

(51) Int. Cl. G09B 5/02

(52) U.S. Cl. CPC G09B 5/02
USPC 434/236

(57) ABSTRACT

Described herein are systems and methods for causing behavior modification of a large population of students by providing electronic messages, referred to as nudges, to the students. A program of nudges is assigned to each student based on collected background information and feedback from the students and/or third parties. A nudge contains a personalized message that is designed to mitigate risk factors and increase academic performance. Feedback from students and third parties is used to proactively modify a program of nudges that are targeted to a student's present needs. The systems and methods described herein may benefit students and educational institutions alike by improving academic outcomes such as GPA and graduation rates, increasing retention rates, improving study habits and mindsets including persistence by transmitting personalized messages to students that nudge their behavior in a positive manner.

### CROSS-REFERENCE TO RELATED APPLICATION

This application claims the benefit of U.S. Provisional Application No. 61/765,668, filed Feb. 15, 2013, the entire contents of which are incorporated herein by reference.

### FIELD OF THE INVENTION

This invention relates to systems and methods for modifying human behavior through personalized feedback rendered on mobile devices. In particular, students receive nudges that correspond to personalized electronic messages and send corresponding feedback about academic events or experiences.

### BACKGROUND OF THE INVENTION

Many different types of professionals are trained to modify or improve behavior of their clients. For example, therapists, counselors and coaches work directly with individuals to modify or enhance behavior to overcome challenges or improve successful outcomes. This form of assistance or intervention may be personalized to an individual based on the specific needs and circumstances of that individual. For example, demographic information and personal experiences provided to or known by a therapist about a client may be used to formulate treatment plans that can increase the likelihood of successfully modifying the client's behavior. However, this form of interaction is time consuming, expensive and imprecise because different professionals use different methods of assessing individuals and different formulas for creating treatment plans.

Some professionals work to improve student outcomes by providing generic information about behavior that leads to achieving academic success. For example, counselors are trained to explain to students general methods about how to succeed in college. Unfortunately, counselors spend minimal amounts of time with every student of a school or focus their entire time on a few students of the school. This occurs because there are too few counselors and too many students in any single school. Moreover, increased student diversity requires counselors to spend more time becoming familiar with cultural, demographic and personal information to provide effective counseling. Consequently, a student body is not uniformly counseled and many students fail academically.

Currently, only 55% of students enrolled full-time in four-year institutions graduate within six years. Further, fewer than 30% of students enrolled at two-year institutions graduate with an associate degree within three years. Research shows that while some students drop out because of finances or poor academic skills, many students drop out because they feel disengaged, confused, or overwhelmed. Unfortunately, there are only a limited number of therapists, counselors, and the like, to provide personalized assistance, and there are only a limited number of hours in a day to help students. Thus, a need exists to provide personal and scalable assistance to a student body to promote academic success.

### SUMMARY OF THE INVENTION

The systems and methods described herein include a platform that engages students to modify their behavior in an academic or educational context. Initially, the platform collects information from one or more sources about students of an educational institution. The collected information for each student is compiled and used to formulate a personalized program that is designed to correct, enhance or optimize student behavior associated with academic performance. The platform may include a remote server, and students may interact with the platform over a network by operating mobile devices. Server 106 sends an electronic message, referred to as a “nudge,” to a mobile device associated with a student based on a personalized program assigned to the student. The personalized electronic message is called a “nudge” because it is one of many messages that are designed to gradually modify behavior to improve academic success of students.

A program including a group of nudges and contents of the nudges are personalized for each student based on the collected information, and are further customized based on feedback received from students and update information provided by third-parties. The nudges are designed to modify or enhance behavior that should lead students to achieve positive academic outcomes. Thus, students that engage with this platform and are assigned a personalized program of predetermined nudges will increase their likelihood of success and retention in educational institutions.

In some embodiments, a system for modifying student behavior includes a memory storing collected information about students and associations between the students and electronic messages, wherein the associations are based on the collected information, and a processor configured to receive feedback from the students and transmit the electronic messages to the students based on the collected information and the feedback, wherein the electronic messages are personalized based on the collected information and the feedback, and are intended to modify student behavior.

In some embodiments, the students transmit feedback and receive electronic messages using an application on mobile devices. In some embodiments, one or more of the electronic messages include a question that requires a selection of a value among a range of values. In some embodiments, the question relates to an emotional state regarding an academic event or experience. In some embodiments, the range of values is displayed on a user interface of a mobile device as selectable icons.

In some embodiments, one or more of the electronic messages include a comment that directs a student to complete a course of action to satisfy an academic event, and the processor sends the student virtual goods after completing the course of action. In some embodiments, the virtual goods are affiliated with an educational institution. In some embodiments, one or more of the electronic messages include a biographic story about a student that shares demographic or academic risk factors in common with the student that received the one or more electronic messages.

In some embodiments, the collected information includes at least one of academic, demographic and survey information. In some embodiments, a table is generated for each of the students, and the table includes categories for classifying the collected information and attributes including binary values or a range of values. In some embodiments, electronic messages associated with a student are predetermined based on weights associated with categories of a table associated with the student. In some embodiments, the categories include at least two of static risks, dynamic risks, academic context, student profile, student characteristics and habit/challenge of focus.

In some embodiments, a method for transmitting electronic messages to students includes storing, in a memory, information about each student and associations between electronic messages and the students, transmitting at least a portion of the associated electronic messages to mobile devices operated by the students, receiving responses from the students about the transmitted electronic messages, and modifying, using a processor, a portion of the electronic messages associated with the students based on the received responses, wherein the electronic messages include content that stimulates changes in behavior associated with academic performance.

In some embodiments, at least a portion of the electronic messages solicit a textual message from a student about an academic event or experience. In some embodiments, at least a portion of the electronic messages include selectable icons that correspond to an emotional state about an academic event or experience. In some embodiments, at least a portion of the electronic messages include a biographic story about overcoming academic risk identified for a student that received the one or more electronic messages based on the collected information. In some embodiments, the method further includes scheduling the electronic messages based on an order of academic events associated with each of the students.

In some embodiments, a method for messaging students includes storing, in a memory, electronic messages, personalized programs that include a subset of the electronic messages and information about students. The method also includes generating, using a processor, a profile for each of the students based on the collected information, assigning one of the personalized programs to each student profile, and transmitting electronic messages to a student that correspond to one or more of the electronic messages associated with the student profile, wherein the electronic messages include contents configured to modify behavioral responses of students to a specific academic event.

In some embodiments, a best-fit calculation is executed by the processor to assign the one of the personalized programs to each student profile. In some embodiments, the method further includes receiving information from a student that designates individuals that are authorized to submit electronic messages that are associated with a profile of the student, sending a message to each designated individual to request a personalized electronic message including a comment about the student, and incorporating, in the memory, one or more comments input by one or more of the designated individuals into the electronic messages associated with the student profile.

### BRIEF DESCRIPTION OF THE DRAWINGS

FIG. 1 illustrates components of the platform architecture, according to some embodiments of the invention;

FIG. 2 is a flowchart showing communications between server-side components of platform and mobile devices, according to some embodiments of the invention; and

FIG. 3 shows four screenshots of a client-side application executing on a mobile device, according to some embodiments of the invention.

### DETAILED DESCRIPTION OF THE INVENTION

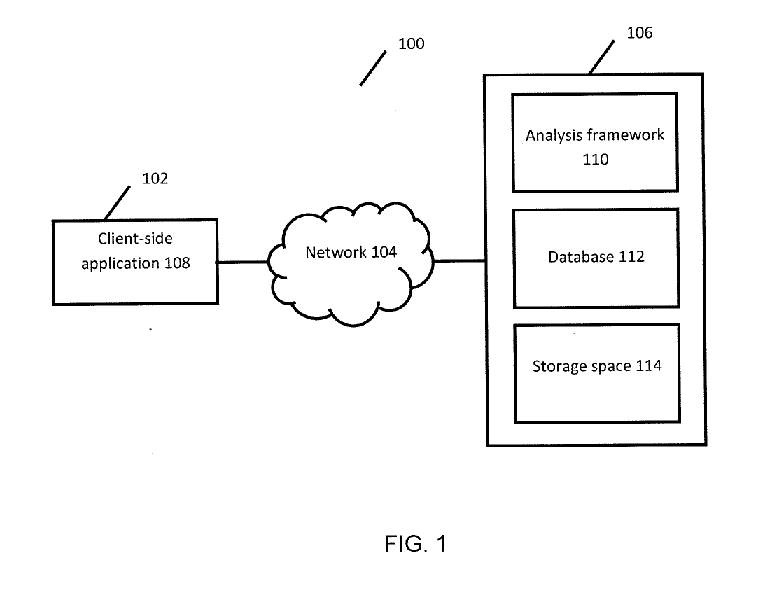

Disclosed herein are systems and methods for engaging with a population of students over an interactive platform to provide transformative behavioral interventions that increase the likelihood of positive academic outcomes. FIG. 1 illustrates components of the platform architecture. System 100 includes components residing on server 106 and components residing on mobile devices 102, depicted as a single box. Server-side components of the platform communicate with client-side mobile devices 102 over a network 104.

The server-side of the platform sends and receives electronic messages to and from a population of students. The electronic messages may include SMS text messages or messages rendered by an application executing on a smartphone. The mobile devices can be any handheld portable devices, such as cellular phones, smartphones, tablets, or the like. The platform provides interactive and personalized messages that elicit behavioral changes from students based on personal, public and private information that affect academic outcomes of the students.

The electronic messages transmitted to individuals may be referred to as “nudges.” A nudge is a personalized electronic message with content that may include text, images, video, audio or any other media that can be rendered on a mobile device. A nudge is personalized because information that is specific to a student is used to tailor the message for that student. The information used to personalize the electronic messages may include demographic, academic, personal or survey information from the student or third parties. In some embodiments, the nudges may be transmitted to individuals other than students, such as family members and friends of the students.

A nudge is designed to target human mechanisms that enhance resiliency, planning skills, social accountability and goal attainment so that students are better prepared to deal with academic setbacks, organize their time and responsibilities, engage their peer network for help, and make progress towards short-term and long-term goals. Consequently, nudges are intended to increase a likelihood that educational institutions will retain students and that the students will have successful academic outcomes. Nudges are delivered to mobile devices by being disseminated by the platform over a network, such as the Internet, a telecommunications network, or any other communications channel. Nudges provide behavioral intervention and the processes that assigns nudges to students are configured to continuously update based on information about students that is provided by the students or third parties. For example, a new nudge may be scheduled for a specific student based on new information received about that student.

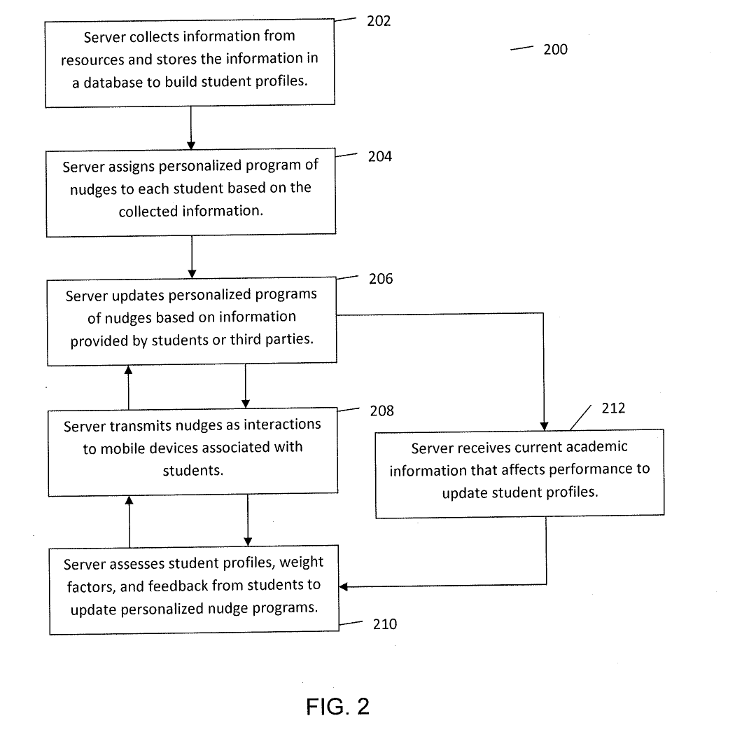

FIG. 2 is a flowchart 200 showing communications between server-side components of the platform and mobile devices operated by students. In step 202, the platform collects information about students from public and private sources, and stores the information in a database to build student profiles. The database may reside in a memory storage space of the server. The information may include academic, demographic survey, and/or personal information. The sources of information may include educational institutions, third parties, students, and the like. In step 204, the platform assigns a personalized program of nudges to each student based on the collected information stored in the database. In some embodiments, the assignment is determined by an analysis framework that uses a best-fit algorithm to compare a collection of predetermined nudges and risk factors identified from the collected information and student feedback. In some embodiments, a program of nudges includes a subset of predetermined electronic messages stored in the memory storage space at the server.

In step 206, the platform may update a personalized program of nudges assigned to a student based on information received from the student and/or third parties. The information may include feedback to previous nudges, updates from a system administrator, updates from third parties, or the like. In step 208, the platform transmits nudges as interactions that are rendered on mobile devices operated by students. In step 210, the platform assesses student profiles, weight factors, and feedback from students to update personalized nudge programs. The weight factors are determined based on the collected information and feedback from students to identify a schedule of nudges that can mitigate risk factors experienced by a particular student.

A bi-directional flow of information is shared between steps 206 through 212 to provide behavior modifying nudges that are timely, to mitigate active risks experienced by students. Thus, a program of nudges may change depending on feedback about nudges that were previously sent to students. In step 212, information from third parties is received by the platform and used to update student profiles and corresponding programs of nudges. For example, the platform may receive current academic information, such as grades and course information, from an educational institution. Nudges may then be tailored to modify behavior that affects grades of particular courses. For example, a student with a lower grade in mathematics may receive a nudge about the status of a mathematics assignment and encourage the student to complete the assignment.

The platform disclosed herein can benefit many students in a variety of academic contexts. Many recent high school graduates and non-traditional students can benefit from this system because it would ease transition into college. The disclosed systems and methods gradually direct students to developed behaviors and habits that are necessary to succeed academically. In some embodiments, the system would direct students on how to manage their time and responsibilities to overcome specific academic challenges. The system would encourage students to leverage resources and peers on campus to make progress on short and long-term goals.

The platform can also benefit educational institutions. Universities and colleges can benefit from this platform because it increases retention rates by increasing personalized support for students on a scalable platform at a reasonable cost, and without a need to hire more counselors. Thus, the system provides a scalable, cost effective, and proactive technology that directly engages and supports students.

The platform is scalable and cost effective because it relies on infrastructure currently in operation and uses technology that is familiar to students. Advances in telecommunications, the Internet, and network based technologies allow millions of students to receive electronic messages at mobile devices. The nudges disseminated by the platform may correspond to alerts that guide, praise, or warn students about academic events or experiences. In some embodiments, the same nudges are transmitted to more than one student. The nudges can be electronic messages that are personalized based on characteristics of a student, and are used to effectively modify or enhance behavior associated with academic performance. Thus, the platform can easily be scaled up for a large number of students with individual schedules of personalized nudges.

### The Platform

The systems and methods described herein may be referred to as the PERSISTENCE PLUS platform, and may include server-side components that communicate over network 114 with client-side components of mobile devices 102. Server 106 may execute server-side software that collects information about students that are registered, enrolled, or affiliated with an educational institution. The sources of information may include students, educational databases, demographic databases and any third party source. For example, the collected information may be received from students, teachers, counselors, high schools, and universities. The content of the information may include text, images, audio, video, and the like. The type of information may include academic, personal, and public information about students, events or experiences. In some embodiments, server 106 may be operated by an educational institution or a third-party service provider.

In some embodiments, server 106 includes analysis framework 110, database 112 and a memory storage space 114. These features may be components of the same server 106, or may reside on different servers or as distributed instances, such as in cloud environments. Analysis framework 110 executes a series of processes to associate nudges with students, update the nudges, and the like. A group of nudges may be referred to as a program. In some embodiments, information collected about a student is processed by a best-fit algorithm to identify nudges that are most suitable for a program associated with a student. In some embodiments, database 112 includes tables that map students to profiles that are associated with programs of nudges. Memory storage space 114 may also contain information retrieved or derived from private and public sources, including the collected information and student feedback. Information that may be stored in memory storage space 114 includes collected information, nudges, programs, associations, feedback, and other data, that is used by analysis framework 110 to execute various analytical processes that are designed to provide personalized nudges.

In some embodiments, analysis framework 110, database 112, and memory storage space 114 reside on different servers other than server 106 operating the server-side platform components. The combination of analysis framework 110, database 112, and storage space 114 may analyze feedback from mobile devices 102 on a periodic basis. Embodiments of the described systems and methods may employ numerous distributed servers and mobile devices 102 to provide an architecture that constitutes system 100.

System 100 may include mobile devices 102, which may include the same or different hardware and software components. Information is communicated over network 114 to mobile devices 102 operated by students. In some embodiments, mobile devices 102 execute client-side applications 108 that are dedicated to communicating with the server-side components of the platform. In some embodiments, mobile devices 102 communicate with server 106 without using dedicated client-side applications. For example, mobile devices 102 and server may communicate via SMS text messages, or through a third party application such as an email application. In some embodiments, client-side application 108 may provide an interactive portal that can be used by students operating mobile devices 102 to render information received from server 106 and accept input, such as text, images, audio and video, for submission to server 106. In some embodiments, client-side application 108 may run a service on mobile devices 102 to collect information about a student.

In some embodiments, software modules included in system 100 can be stored on non-transitory computer readable mediums. The software modules can be executed by CPUs on mobile devices 102 and/or server 106. Server 106 may be the same or different from servers operated by an educational institution or third party service provider. In some embodiments, an educational institution may pay for services to engage with students affiliated with the institution. In some embodiments, system 100 may be connected to many educational institutions to engage with students across a diverse population.

Mobile devices 102 may transmit information over a communications network, such as the Internet. Other communications technology for use by mobile devices 102 may include, but are not limited to, any combination of wired or wireless digital or analog communications channels, such as phone systems (e.g., cellular, RF, or IP-based). These communications technologies can include Ethernet, Wi-Fi, BLUETOOTH, and other wireless radio technologies. Network 114 can include, for example, a cellular phone network, a local area network (LAN), a wide area network (WAN), the Internet, or combinations thereof.

Mobile devices 102 can be any communications device for sending and receiving voice, video, or data, for example, a smartphone, tablet or laptop computer, a wired or wireless machine, device, or combinations thereof. Mobile devices 102 can also be any portable media device such as a network connected digital camera, media player, or another portable media device. These devices may be configured to send and receive voice or data through a cellular network, web browser, dedicated application, or other portal. Mobile devices 102 and server 106 can be or can include computers running ANDROID, BLACKBERRY OS, MICROSOFT WINDOWS, WINDOWS PHONE, MAC iOS, UNIX, LINUX or any operating system (OS) or platform. Mobile devices 102, server 106, and components residing therein may include a communications interface. A communication interface may allow mobile devices 102 to connect directly, or over network 114, to another mobile device, server or another device. In some embodiments, mobile devices 102 can be connected to other devices or servers via a wireless interface.

In some embodiments, parts of analysis framework 110, database 112, and storage space 114 may be distributed across several servers, mobile devices, or combinations thereof. Server 106 of these components or mobile devices may each include an input interface, processor, memory, communications interface, output interface, or combinations thereof, interconnected by a bus. The memory used in these components may include volatile and non-volatile storage. For example, memory storage may include a solid-state drive (SSD), a read only memory (ROM) in a hard disk device (HDD), random access memory (RAM), and the like. The OS and applications of mobile devices 102 may be stored on SSD.

Specific software modules that implement embodiments of the described systems and methods may be incorporated in applications on server 106 or mobile devices 102. The software modules may execute under control of an OS, as detailed above. When stored on server 106, embodiments of analysis framework 110, database 112, and storage space 114 can function and be maintained in a manner that is substantially, or totally transparent to students operating mobile devices 102.

Thus, information about a student, academic events, experiences, and the like are sent to server 106 over a communications network (such as the Internet) or through another networked facility (such as an intranet) or from a dedicated input source, or combinations thereof. In some embodiments, applications that are installed on mobile devices 102 can originate from a wide variety of sources, such as commercial services operated by carriers or third party vendors.

Under control of the OS, applications that run on server 106 or mobile devices 102 exchange commands and data with external sources, via a network connection or USB connection to transmit and receive information during execution of the platform.

Server 106 or mobile devices 102 may be connected to input devices, such as a keyboard or mouse. A display, such as a conventional color monitor, and printer, such as a conventional laser printer, may also be connected to output interfaces. The output interfaces provide requisite circuitry to electrically connect and interface the display and printer to server 106 or mobile devices 102. Through these input and output devices, a user can access and install applications on mobile devices 102.

Analysis framework 110, database 112, or memory storage space 114 may be embodied in a product that an educational institution can install on its server. The combination of these components can analyze feedback about students on a recurring schedule. Then, after using these components, the educational institution can monitor the academic performance of students and intervene when necessary.

Client-side application 108, analysis framework 110, database 112, or storage space 114 could be embodied as JAVA tools, which means that they can run on any platform that is JAVA enabled. Embodiments of these components can run on servers that provide websites for administrators to access these components remotely over a network. Anyone with administrative access to server 106 can connect to, and use, visualization tools provided by system 100. These components can run on any type of server, including virtual servers or actual machines, and can be designed to operate in any computing environment because they have very few requirements for underlying hardware and operating systems.

System 100 may be embodied on a distributed processing system to break processing apart into smaller jobs that can be executed by different processors in parallel. The results of the parallel processing could then be combined once completed. In some embodiments, features of system 100 can be provided to an educational institution as a subscribed service.

The systems and methods described herein send updates of data from mobile device 102 over network 114 to server 106. Database 112 stores collected information and feedback from across a population of mobile devices 102. Thus, system 100 gains significant speed, efficiency and effectiveness due to its unified way of interacting with a large population of students.

### Nudges

The electronic messages transmitted by the platform may be referred to as “nudges.” Nudges may be personalized for a group of one or more students. For example, a group of nudges may be sent to a specific class of students enrolled at a university. In some embodiments, nudges are personalized for each student. The platform assigns one or more students to one or more programs of nudges. A program of nudges may include one or more nudges. Nudges may be unique to a single program or can be common to two or more programs.

In some embodiments, a program of nudges includes a scheduled order to deploy its nudges. The nudges may be deployed at random, periodically, relative to a date or time of an event, such as an exam, or in response to feedback from a student. In some embodiments, different sequences of nudges may be deployed depending on feedback received from a student or a third party as the student progresses academically. In some embodiments, a sequence of nudges sent to a student's mobile device is determined by using a best-fit algorithm that compares feedback from the student and/or a third party and nudges belonging to a program that was initially assigned to the student.

A program of nudges is initially assigned to a student based on information about the student that has been collected by the platform. The information may include academic, demographic, or personal information, or any information that describes characteristics or risk factors of a particular student. The information is categorized and assigned weights to determine the most appropriate program for a student. In some embodiments, a best-fit algorithm is used to assign a program to a student by comparing statistical information about a student to programs that are designed to modify behavior of individuals susceptible to particular risk factors.

In some embodiments, any information about a student can be used by to assign a program of nudges to the student and subsequently select the nudges from that program that will be transmitted to the student's mobile device. In some embodiments, nudges are personalized for individual students based on college and course information, student demographics and performance indicators, and data shared by students or third parties.

Specific factors used by system 100 to assign a program to a student or to select a nudge for deployment may include, but are not limited to, gender, age, fulltime or part-time enrollment status, first-generation college student status, amount of hours working outside of school per term, school year, degree or certificate sought, major selected, undeclared major status, selected habits of focus, selected goals of focus, challenges shared, amount of time spent on classwork, responsiveness to previous nudges, mood state, course enrollment, course schedule, current assignment and project grades, final grades, previous academic history, children in household, previous military experience, presence of test anxiety, student profile assessment, sense of belonging, scores on behavioral scales focused on self-efficacy and help-seeking traits, semester week, and existence and breadth of support network.

The collected information for each student is used to identify factors that are categorized, and the categories are assigned weights that depend on the quality and quantity of information available about that particular student. In some embodiments, the categories include risk factors associated with academic performance. In some embodiments, factors within a category can be further weighed to determine more personalized nudges. TABLE 1 shown below provides an example of a profile or schema that could be used to assign a program to a student and to deliver personalized nudges to the student in a particular order. In this example, the categories include: static risks, dynamic risks, academic context, student profile, student characteristics, and habit/challenge of focus. In some embodiments, the categories include a subset comprising one, two, three, four or more of the categories shown in TABLE 1.

| Static | Dynamic | Academic | Student | Student | Habit/Challenge |
|---|---|---|---|---|---|
| Risks | Risks | Context | Profile | Characteristics | of Focus |
| (5%) | (45%) | (5%) | (10%) | (20%) | (15%) |

In this example, factors are listed within each category in their priority weighting order.

| | | | | | |
|---|---|---|---|---|---|
| 1^{st} Gen (Y) | Responsiveness | College | Age (Adult | Vision | Habit selected |
| | (Lack of) | (UWT) | Learner) | (support | (Study 2 hrs a |
| | | | | family) | day) |
| School Yr | Mood state | Course Load | Race/Ethnicity | Motivation | Challenge |
| (1^{st}) | (<6 or 2.5 stars) | (5) | (Hispanic) | (new house) | selected |
| | | | | | (Waking early) |
| Academic | Current grades | Gatekeeper | Military (Y) | Self-efficacy | Goal progress |
| Record | (<2.0) | (Math) | | (weak) | (4/7) |
| (<2.0) | | | | | |
| Hrs Working | Mood trend | Schedule | Major | Help-seeking | |
| (>20) | ( [symbol] ) | (Test Friday) | (Undecided) | (weak) | |
| Undeclared | Time spent | Timing of Term | | Supporter | |
| Major (Y) | (<5 hrs a week) | (1^{st} ¼) | | network | |
| | | | | (moderate) | |
| FT/PT | Test anxiety | | | Sense of | |
| (PT) | (Y) | | | community | |
| | | | | belonging | |
| | | | | (moderate) | |
| Children (Y) | Challenge | | | | |
| | shared (Y) | | | | |
| Gender (M) | | | | | |

Each category may include several factors. For example, the category “static risks” in TABLE 1 includes the factors: first generation college student, school year, academic record, hours working outside of school, undeclared major status, full-time or part-time enrollment status, children, and gender. Some factors may include attributes that have binary values such as yes or no, and other factors may have a range of values, such as hours working. Each factor that belongs to a category may contribute to a weight associated with a category. For example, TABLE 1 shows a weight of 5% associated with the “static risks” category. These weighted categories and/or factors can be used to determine a best-fit program of nudges for a student.

A table that contains classification and weighing data, similar to TABLE 1 above, may be stored on database 112 or any portion of memory storage space 114 that resides on server 106 of system 100. A table may correspond to a profile that is associated with a student and may be used to assign a program of nudges. An assigned program of nudges provides a personalized experience for students. For example, the nudge weighting schema shown in TABLE 1 may be for a Hispanic 43-year old male who is starting college while working full-time, and who has scored high on several dynamic factors and characteristics indicating that he is at greater risk of not persisting in college.

In some embodiments, nudges are tagged according to their relevancy to a specific risk factor. Nudges can include comments or questions designed to foster specific behaviors or mindsets in students. For example, a nudge that is tagged for test anxiety may show the text, “Take a few minutes before your test tomorrow to write down your worries. Research shows that this process clears your mind and allows your working memory to improve for test time.” A student with a profile that indicates test anxiety and a high dynamic risk, as shown in TABLE 1, is likely to receive this type of nudge before an upcoming exam.

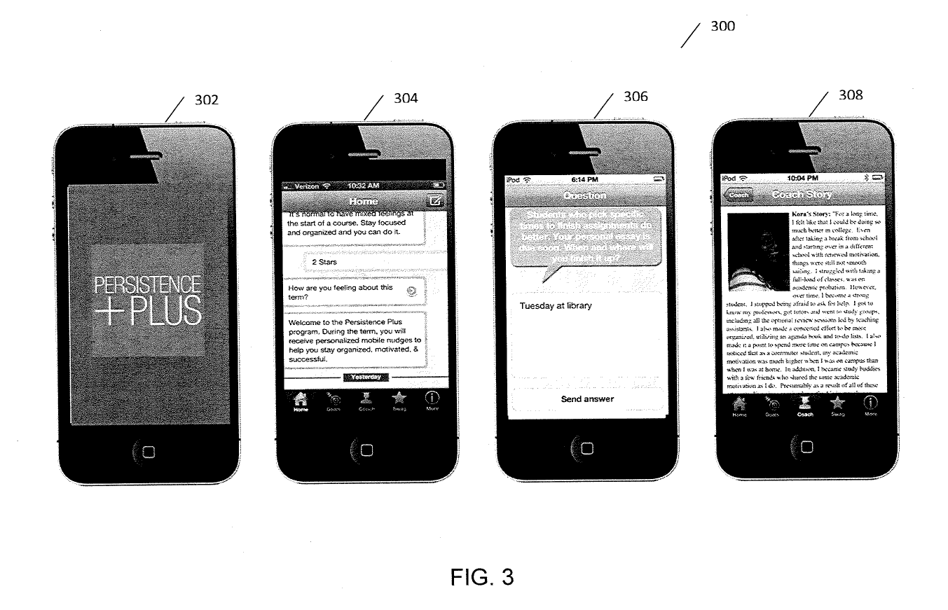

FIG. 3 shows four screenshots 300 of client-side application 108 executing on a mobile device. Screenshot 302 corresponds to a loading page of client-side application 108 executing on a mobile device. Screenshot 304 shows nudges delivered to a student's mobile device. The nudges include statements and question soliciting a response. For example, a student may respond to a question by selecting a number of stars or other icons displayed on the user interface of client-side application 108. In some embodiments, the displayed icons correspond to a range of emotions associated with an academic event or experience. Screenshot 306 includes a nudge asking a question, and a text field for a user to respond with text typed into the text field. The student can tap the displayed “send answer” button to send a typed response. Screenshot 308 corresponds to a LIFEBITS, as detailed below, which is a nudge with a biographic story about a student that overcame similar challenges faced by the student that received the nudge.

In some embodiments, friends, family members, or other third parties, can provide personalized nudges to students. For example, a student can use client-side application 108 executing on a mobile device, or any other communications portal, to input names and contact information of family and friends. In some embodiments, the platform labels these identified individuals as “fans” of the student. The fans associated with a student can then provide personalized nudges, which are referred to as “Nice Nudges.” In some embodiments, a Nice Nudge may be sent to a student during stressful periods in an academic term.

The process for generating nice nudges requires fans to access system 100 to input the content of the nice nudges. Initially, fans are sent electronic messages that include a link to a portal. In some embodiments, the electronic messages sent to fans correspond to nudges about a student that are sent to the fans. In some embodiments, the fans can access a web portal using any conventional web browser or dedicated application. The fans are guided by the web portal to write positive messages of encouragement and support for the student. The nice nudges are delivered at designated times to the student through client-side application 108 executing on the student's mobile device. In some embodiments, the portal requests fans to send or schedule nice nudges at different times during an academic term, which may depend on stressors experienced by the student as determined by the classification and weighting system detailed above. In some embodiments, nice nudges are collected at any time, stored in memory storage space 114 of server 106 and transmitted to a student's mobile device during times selected according to the classification and weighting system detailed above.

Student feedback and/or feedback from third parties may change a program of nudges initially assigned to the student. In some embodiments, a frequency and time for transmitting nudges or other therapeutic or counseling intervention mechanisms may be based in part on the categories, factors, and respective weights that include a student profile. In addition, feedback provided by a student can influence subsequent nudges. In some embodiments, nudges in response to student feedback may directly answer questions posed by the student. In some embodiments, responses to nudges may be sent directly to system 100 over network 114, or through third party portals or individuals associated with the student.

In some embodiments, system 100 may also determine when to send nudges based on a time when students have previously responded to nudges. For example, some students may frequently respond to nudges at night, while others respond more frequently to nudges in the morning. Some individuals may respond better to fewer nudges during a period of time (e.g., certain days, weeks, months), while other students may require a higher recurring frequency of nudges. Consequently, a timing and frequency of nudges sent to students may change to continually modify or enhance human behavior as goals are set and met by the students. Thus, the timing and frequency of sending nudges may depend on specific habits of a student in an effort to engage the student to modify behaviors that affect academic performance.

In some embodiments, nudges may include biographies of other students who overcame similar challenges that are presently being encountered by a student. These biographies may be referred to as “LIFEBITS.” The biographies may include a narrative and pictures from students that describe their success stories. These types of nudges are tagged with a label for students dealing with similar challenges.

For example, a student of the weighing schema shown in TABLE 1 above is likely to receive a LIFEBITS such as the one shown below, complete with a photo of a similar student, named Jason, who is a Hispanic male in his late 30 s with a family, and who initially shied away from help when he was struggling in school.

“Jason's Story: Struggled to be Successful: for a long time, I felt like that I could be doing so much better in college. Even after taking a break from school and starting over in a different school with renewed motivation, things were still not smooth sailing. I struggled with a full-load of classes, going to work, and being available for my family. However, over time, I became a strong student. I stopped being afraid to ask for help. I got to know my professors, got tutors and went to study groups, including all the optional review sessions led by teaching assistants. I also made a concerted effort to be more organized, utilizing an agenda book and to-do lists. I also made it a point to spend more time on campus because I noticed that as a commuter student, my academic motivation was much higher when I was on campus than when I was at home. In addition, I became study buddies with a few friends who shared the same academic motivation as I do. As a result of all of these attempts, I've since received mostly A's in my classes, and am on-track to graduating with honors.”

“Knowing What I Know Now: My biggest advice for anyone who is struggling, or potentially about to struggle, is to ask for help. At least for me, there was a subconscious or side thing that was going on that was keeping me from asking from help. But when I asked for it, I got it. There really is no shame in asking. In fact, it saves a lot of grief, makes life a lot easier and much more pleasant.”

In some embodiments, nudges include college-affiliated virtual goods, referred to as “swag,” that are awarded to promote greater engagement between students and their college, and to encourage certain behaviors. For example, the student with the weighting schema shown in TABLE 1 is likely to receive an item of tailored swag, such as a virtual mug icon reading “Future Alum of <COLLEGE NAME>” when the student responds to a question contained in a nudge. Another student with a weighting schema that has a greater focus on their new academic habit may receive swag of his or her college pendant after maintaining a habit for a week.

In some embodiments, nudges may include one or more personalized goals and habits that are suggested to a student. The students can select one or more of the suggested goals or habits and the platform can encourage the student to pursue the goals on a daily, weekly, or monthly basis. For example, the student with the weighing schema of TABLE 1 above may receive a personalized set of goals that focus on establishing study habits and support structures for adult learners.

In some embodiments, a program of nudges assigned to a student may be reassessed based on new information collected throughout an academic term. For example, a student who has stopped responding to interactive nudges and is struggling academically will be reassigned to a nudge program the weighs those factors more significantly.

In some embodiments, system 100 includes a learning component that updates nudges tagged with risk factors based on actual student outcomes for students that have been assigned different programs and engaged with system 100 for a period of time. For example, information such as grades, persistence and retention of students receiving nudges may be used to modify how nudges are tagged for use with other students. This learning component improves the accuracy for selecting effective nudges for particular students that share risk factors that are similar to other students.

In some embodiments, administrators experienced with behavioral research and education may monitor the responses collected by the platform so that they can intervene at any point in time with a nudge for a specific student situation.

The systems and methods disclosed herein target behavioral mechanisms that enhance resiliency, planning skills, social accountability and goal attainment. While several embodiments have been described herein that are exemplary of the present invention, one skilled in the art will recognize additional embodiments within the spirit and scope of the invention. The platform described herein identifies optimal nudges for different student profiles in a variety of settings. The end result is that the most appropriate nudges are delivered to the students at the right time.

Modifications and variations can be made to the disclosed embodiments without departing from the scope of the disclosure. Those skilled in the art will appreciate that the applications of the embodiments disclosed herein are varied. For example, system 100 may be applied to any users that seek to modify a particular behavior or habit, such as smoking, drinking, over-eating, and the like. The systems and methods disclosed herein can be applied in non-academic contexts, such as at work, home, or socially out with friends. Accordingly, additions and modifications can be made without departing from the principles of the disclosure. In this regard, it is intended that such changes would still fall within the scope of the disclosure. Therefore, this disclosure is not limited to particular embodiments, but is intended to cover modifications within the spirit and scope of the disclosure.

1. A system for modifying student behavior, comprising:
a memory storing collected information about a plurality of students and associations between the plurality of students and a plurality of electronic messages, wherein the associations are based on the collected information; and
a processor configured to receive feedback from the plurality of students and transmit the plurality of electronic messages to the plurality of students based on the collected information and the feedback, wherein the plurality of electronic messages are personalized based on the collected information and the feedback, and are intended to modify student behavior.

2. The system of claim 1, wherein the plurality of students transmit feedback and receive electronic messages using an application on mobile devices.

3. The system of claim 2, wherein one or more of the plurality of electronic messages comprises a question that requires a selection of a value among a range of values.

4. The system of claim 3, wherein the question relates to an emotional state regarding an academic event or experience.

5. The system of claim 3, wherein the range of values is displayed on a user interface of a mobile device as a plurality of selectable icons.

6. The system of claim 2, wherein one or more of the plurality of electronic messages comprises a comment that directs a student to complete a course of action to satisfy an academic event, and the processor sends the student virtual goods after completing the course of action.

7. The system of claim 6, wherein the virtual goods are affiliated with an educational institution.

8. The system of claim 2, wherein one or more of the plurality of electronic messages comprises a biographic story about a student that shares demographic or academic risk factors in common with the student that received the one or more electronic messages.

9. The system of claim 2, wherein the collected information comprises at least one of academic, demographic and survey information.

10. The system of claim 9, wherein a table is generated for each of the plurality of students, and the table comprises categories for classifying the collected information and attributes comprising binary values or a range of values.

11. The system of claim 10, wherein a plurality of electronic messages associated with a student are predetermined based on weights associated with categories of a table associated with the student.

12. The system of claim 11, wherein the categories comprise at least two of static risks, dynamic risks, academic context, student profile, student characteristics and habit/challenge of focus.

13. A method for transmitting electronic messages to a plurality of students, comprising:
storing, in a memory, information about each of a plurality of students and associations between a plurality of electronic messages and the plurality of students;
transmitting at least a portion of the associated electronic messages to mobile devices operated by the plurality of students;
receiving responses from the plurality of students about the transmitted electronic messages; and
modifying, using a processor, a portion of the plurality of electronic messages associated with the plurality of students based on the received responses, wherein the plurality of electronic messages comprise content that stimulates changes in behavior associated with academic performance.

14. The method of claim 13, wherein at least a portion of the plurality of electronic messages solicit a textual message from a student about an academic event or experience.

15. The method of claim 13, wherein at least a portion of the plurality of electronic messages comprises a plurality of selectable icons that correspond to an emotional state about an academic event or experience.

16. The method of claim 13, wherein at least a portion of the plurality of electronic messages comprise a biographic story about overcoming academic risk identified for a student that received the one or more electronic messages based on the collected information.

17. The method of claim 13, further comprising scheduling the plurality of electronic messages based on an order of academic events associated with each of the plurality of students.

18. A method for messaging a plurality of students, comprising:
storing, in a memory, a plurality of electronic messages, a plurality of personalized programs that comprise a subset of the plurality of electronic messages and information about a plurality of students;
generating, using a processor, a profile for each of the plurality of students based on the collected information;
assigning one of the plurality of personalized programs to each student profile; and
transmitting electronic messages to a student that correspond to one or more of the plurality of electronic messages associated with the student profile, wherein the plurality of electronic messages comprise contents configured to modify behavioral responses of students to a specific academic event.

19. The method of claim 18, wherein a best-fit calculation is executed by the processor to assign the one of the plurality of personalized programs to each student profile.

20. The method of claim 18, further comprising:
receiving information from a student that designates individuals that are authorized to submit electronic messages that are associated with a profile of the student;
sending a message to each designated individual to request a personalized electronic message comprising a comment about the student; and
incorporating, in the memory, one or more comments input by one or more of the designated individuals into the plurality of electronic messages associated with the student profile.
